(19) United States
(12) Patent Application Publication
(10) Pub. No.: US 2026/0369934 A1
(43) Pub. Date: Nov. 19, 2026

(54) CONNECTOR DIELECTRIC CROSSTALK MITIGATION

(71) Applicant: Molex, LLC, Lisle, IL (US)

(72) Inventors: Suraj Sridhar, Naperville, IL (US); Dominic Steier, Naperville, IL (US); Chi-Wen Hsu, Taoyuan City (TW)

(21) Appl. No.: 19/558,485

(22) Filed: Mar. 6, 2026

Related U.S. Application Data
(60) Provisional application No. 63/804,712, filed on May 13, 2025.

(51) Int. Cl. H01R 13/6461; H01R 13/6597

(52) U.S. Cl. CPC H01R 13/6461; H01R 13/6597

(57) ABSTRACT

Connectors with dielectric inserts tailored for crosstalk mitigation and other benefits are described. An example connector includes a housing comprising a front port opening and a wafer assembly positioned in the housing. The wafer assembly includes a signal terminal and a dielectric insert supporting the signal terminal. The dielectric insert extends over and contacts a portion of a surface of the signal terminal along a length of the signal terminal. The portion of the surface of the signal terminal is 50% or less than a total surface region of the surface along the length. A second portion of the surface of the signal terminal along the length is exposed within a window of the dielectric insert. The dielectric inserts can help to reduce crosstalk and other undesirable effects, including far end crosstalk (FEXT), resonant peaks, and other effects, while reducing the cost and complexity required by other approaches.

### BACKGROUND

The amount of data processed by computers, computing systems, and computing environments continues to increase. Data centers, for example, can include hundreds of computing and networking systems interconnected using optical cables, copper cables, and a wide range of different connectors, cable assemblies, and terminations between them. The data throughput of these interconnect systems is high and increasing. As examples, many data centers incorporate a combination of 10 Gigabit Ethernet (10GbE), 25 GbE, 50 GbE, and 100 GbE network interfaces and interconnects. 200 GbE, 400 GbE, and 800 GbE interconnection technologies are also being developed and deployed. Other interconnection solutions rely upon 56 Gigabit per second (Gb/s), 112 Gb/s, and 224 Gb/s interconnection technologies, and interconnection technologies are being developed to support higher data rates. A range of cable assemblies and connectors are available for the data interconnects. A variety of different designs exist for the cable assemblies and connectors.

It can be particularly challenging to design connectors for high data rate applications and interconnection systems due to a number of competing concerns. High data rate interconnection systems often rely upon differentially coupled signal pairs in which two conductors are arranged in a pair to transmit a differential signal. The signal being transmitted is embodied by the electrical voltage/current difference measured between the two conductors. Differential signaling can be helpful to avoid or reject spurious signals and crosstalk and to avoid inadvertent signaling modes among adjacent signal pairs. In connector interfaces, ground terminals can be relied upon to create a current return path to electrical ground, provide shielding between differential pairs, and for other purposes. It can still be challenging to reject spurious signals and crosstalk and to avoid inadvertent signaling modes among adjacent signal pairs even with ground terminals and ground shield networks.

### SUMMARY

Certain aspects of the concepts and embodiments described herein are summarized below. The aspects are representative and not exhaustively listed. In alternate embodiments, certain features and elements can be added, omitted, and interchanged with each other. Additionally, variations, extensions, and modifications to the example embodiments can be achieved by those skilled in the art without departing from the concepts, so as to encompass equivalent and related structures. Connectors with dielectric inserts tailored for crosstalk mitigation and other benefits are described. An example connector includes a housing comprising a front port opening and a wafer assembly positioned in the housing. The wafer assembly includes a signal terminal and a dielectric insert supporting the signal terminal. The dielectric insert extends over and contacts a portion of a surface of the signal terminal along a length of the signal terminal. The portion of the surface of the signal terminal contacted by the dielectric insert is 50% or less than a total surface region of the surface along the length in one example.

In other aspects, the wafer assembly also includes a shield, the surface of the signal terminal is a top surface of the signal terminal, and a bottom surface of the signal terminal faces the shield. The surface of the signal terminal can be a top surface of the signal terminal, and a bottom surface and side surfaces of the signal terminal can be exposed along the length. The dielectric insert can also extend over and contact an entire surface of the signal terminal along a second length of the signal terminal.

In other aspects, the wafer assembly also includes a ground terminal, and the dielectric insert extends over and contacts an entire surface of the ground terminal along the length of the signal terminal. The dielectric insert also contacts the entire surface of the ground terminal along an entire length of the dielectric insert itself. The wafer assembly also includes both a shield and a ground terminal in some cases, the dielectric insert extends over and contacts an entire top surface of the ground terminal along the length of the signal terminal, and a bottom surface of the ground terminal contacts and is electrically coupled to the shield.

The wafer assembly can also include a second dielectric insert supporting the signal terminal in some cases, and the second dielectric insert extends over and contacts a second portion of the surface of the signal terminal along a second length of the signal terminal. The wafer assembly can also include a second signal terminal in some cases, and the dielectric insert extends over and contacts a portion of a surface of the second signal terminal along the length of the signal terminal and the second signal terminal within a window of the dielectric insert.

An example wafer assembly includes a signal terminal, a ground terminal, and a dielectric insert supporting the signal terminal and the ground terminal. The dielectric insert extends over and contacts a portion of a surface of the signal terminal along a length of the signal terminal. The portion of the surface of the signal terminal is 50% or less than a total surface region of the surface along the length.

The wafer assembly can also include a shield, the surface of the signal terminal is a top surface of the signal terminal, and a bottom surface of the signal terminal faces the shield. The surface of the signal terminal is a top surface of the signal terminal in one example, and a bottom surface and side surfaces of the signal terminal are exposed along the length.

The wafer assembly can also include a second dielectric insert supporting the signal terminal in some cases, and the second dielectric insert extends over and contacts a second portion of the surface of the signal terminal along a second length of the signal terminal. The wafer assembly can also include a second signal terminal in some cases, and the dielectric insert extends over and contacts a portion of a surface of the second signal terminal along the length of the signal terminal and the second signal terminal within a window of the dielectric insert.

Another example connector includes a housing having a slot for insertion of a board card edge interface and a wafer assembly positioned in the housing. The wafer assembly includes a pair of signal terminals and a dielectric insert supporting the pair of signal terminals. The dielectric insert extends over and contacts a portion of a surface of each signal terminal among the pair of signal terminals along a length of the pair of signal terminals. The portion of the surface of each signal terminal is 50% or less than a total top surface region of each signal terminal along the length in one example.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 illustrates a perspective view of an example connector according to various embodiments of the present disclosure.

FIG. 2A illustrates a perspective view of the wafer assemblies of the connector shown in FIG. 1, with the housing of the connector omitted from view, according to various embodiments of the present disclosure.

FIG. 2B illustrates a side view of the wafer assemblies of the connector shown in FIG. 2A according to various embodiments of the present disclosure.

FIG. 2C illustrates a perspective view of the wafer assemblies of the connector shown in FIG. 2A, with parts exploded away from each other, according to various embodiments of the present disclosure.

FIG. 3A illustrates the sectional view designated A-A in FIG. 2B.

FIG. 3B illustrates the detail view designated AA in FIG. 3A.

FIG. 3C illustrates the detail view designated BB in FIG. 2A.

FIG. 3D illustrates the sectional view designated B-B in FIG. 2B.

FIG. 3E illustrates the sectional view designated C-C in FIG. 2B.

FIG. 4 illustrates a back view of a dielectric insert and terminal conductors of another example wafer assembly according to various embodiments of the present disclosure.

### DETAILED DESCRIPTION

The amount of data processed by computers, computing systems, and computing environments continues to increase. Data centers, for example, can include hundreds of computing and networking systems interconnected using optical cables, copper cables, and a wide range of different connectors, cable assemblies, and terminations between them.

The small form-factor pluggable (SFP) module format is a compact, hot-pluggable network interface module format used for data interconnects, and SFP modules are commonly used for interconnects in data centers. An SFP interface on a computing or networking system is a modular slot for a media-specific transceiver, such as a copper or fiber-optic cable assembly. Cable assemblies can include SFP transceiver modules at one or both ends of a copper, fiber-optic, or other type of interconnecting cable. SFP transceiver modules can be inserted into SFP interfaces for data interconnections.

A range of SFP transceiver modules are currently available, such as small form-factor pluggable double density (SFP-DD), compact small form-factor pluggable (cSFP), SFP+, quad small form-factor pluggable (QSFP), quad small form-factor pluggable double density (QSFP-DD), octal small form factor pluggable (OSFP), and others. An active electrical cable (AEC) assembly can include an SFP transceiver module at the free end of cables or a cable bundle. An AEC assembly can include more printed circuit boards (PCBs) and semiconductor chips for signal re-timing, noise reduction, signal integrity improvement, and other functions. SFP transceiver modules often include one or more PCBs with semiconductor circuit devices or chips and other circuitry mounted to the PCBs. The PCBs can provide PCB-style tip interfaces at one end or side of the module, for insertion into a mating connector.

Connectors used in high data rate applications are typically designed to meet a range of mechanical and electrical requirements. To achieve the desired mechanical and electrical requirements, the connectors used in such applications often incorporate one or more wafer assemblies. The wafer assemblies can include an dielectric inserts that support signal and ground terminal conductors in the wafer assemblies. The use of wafer assemblies can be helpful to manufacture connectors capable of achieving high data rates using a number of different assembly processes. It is still challenging, in any case, to design connectors having the size and conductor density needed for new systems, while also maintaining the electrical characteristics needed for the data rates and signal integrity specified by emerging industry standards and customer specifications.

In the context outlined above, connectors with dielectric inserts tailored for crosstalk mitigation and other benefits are described. An example connector includes a housing comprising a front port opening and a wafer assembly positioned in the housing. The wafer assembly includes a signal terminal and a dielectric insert supporting the signal terminal. The dielectric insert extends over and contacts a portion of a surface of the signal terminal along a length of the signal terminal. The portion of the surface of the signal terminal comprises 50% or less than a total surface region of the surface along the length. A second portion of the surface of the signal terminal along the length is exposed within a window of the dielectric insert. The dielectric inserts can help to reduce crosstalk and other undesirable effects, including far end crosstalk (FEXT), resonant peaks, and other effects, while reducing the cost and complexity required by other approaches.

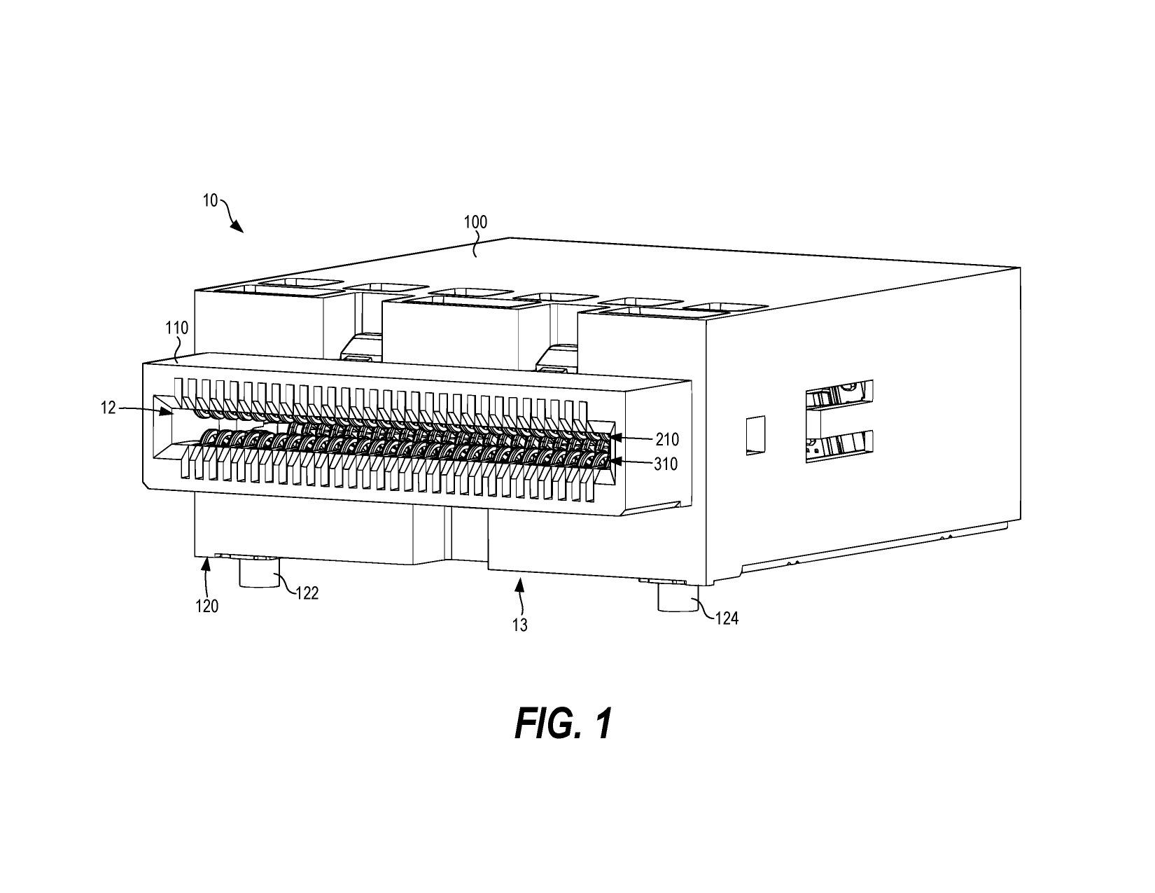

Turning to the drawings, FIG. 1 illustrates a perspective view of an example connector 10 according to various embodiments of the present disclosure. The connector 10 is illustrated as a representative example of a connector including multi-point ground shield terminal walls and compliant shields. The concepts described herein can be extended to use with a range of other connectors of different types, styles, and formats, however. The connector 10 is not drawn to any particular scale or size in the drawings. The shape, size, proportion, and other characteristics of the connector 10 can vary as compared to that shown. For example, the connector 10 can accommodate larger or smaller rows of terminal conductors (e.g., be wider or narrower), and other variations are within the scope of the examples described herein. A number of connectors similar to the connector 10 can be stacked or arranged side-by-side, for higher data rate interconnection systems. Additionally, one or more of the parts or components of the connector 10, as illustrated in the drawings and described herein, can be omitted in some cases. The connector 10 can also include other parts or components that are not illustrated.

The connector 10 includes a front port opening 12 and a terminal foot 13. The connector 10 is designed to establish and maintain electrical connections with contact pads on opposing sides of a board card edge interface. As one example, the PCB-style tip of an SFP transceiver module can be inserted into the front port opening 12 of the connector 10. The connector 10 includes four (4) rows of signal terminal conductors and ground terminal conductors, and each row is supported by a separate wafer assembly. The signal and ground terminal conductors are supported by wafer assemblies of the connector 10, as described in additional detail below. The signal and ground terminal conductors extend from the front port opening 12 to the terminal foot 13 of the connector 10, for the communication of data signals through the connector 10.

The connector 10 is designed to provide shielding and maintain the signal integrity of differential signals that are transmitted over the signal terminal conductors within the connector 10, as they extend from the front port opening 12 to the terminal foot 13. The connector 10 can be designed as a mating connector for use with SFP or related interconnection systems, as one example, although the connector 10 can be mated with other types of board card edge interconnection systems. The concepts described herein are also not limited to use with any particular type or style of interconnection system. The terminal foot 13 of the connector 10 can be designed as a surface mount technology (SMT) foot, for coupling to the surface of a PCB, but the connector 10 can also be designed to have through-hole or other lead styles of terminal conductors at the terminal foot 13. The concepts described herein can also be extended to connectors that incorporate bypass cables, and certain signal and ground terminal conductors of the connector 10 can be directly coupled to one or more twinax cables in some cases, for signal bypass applications.

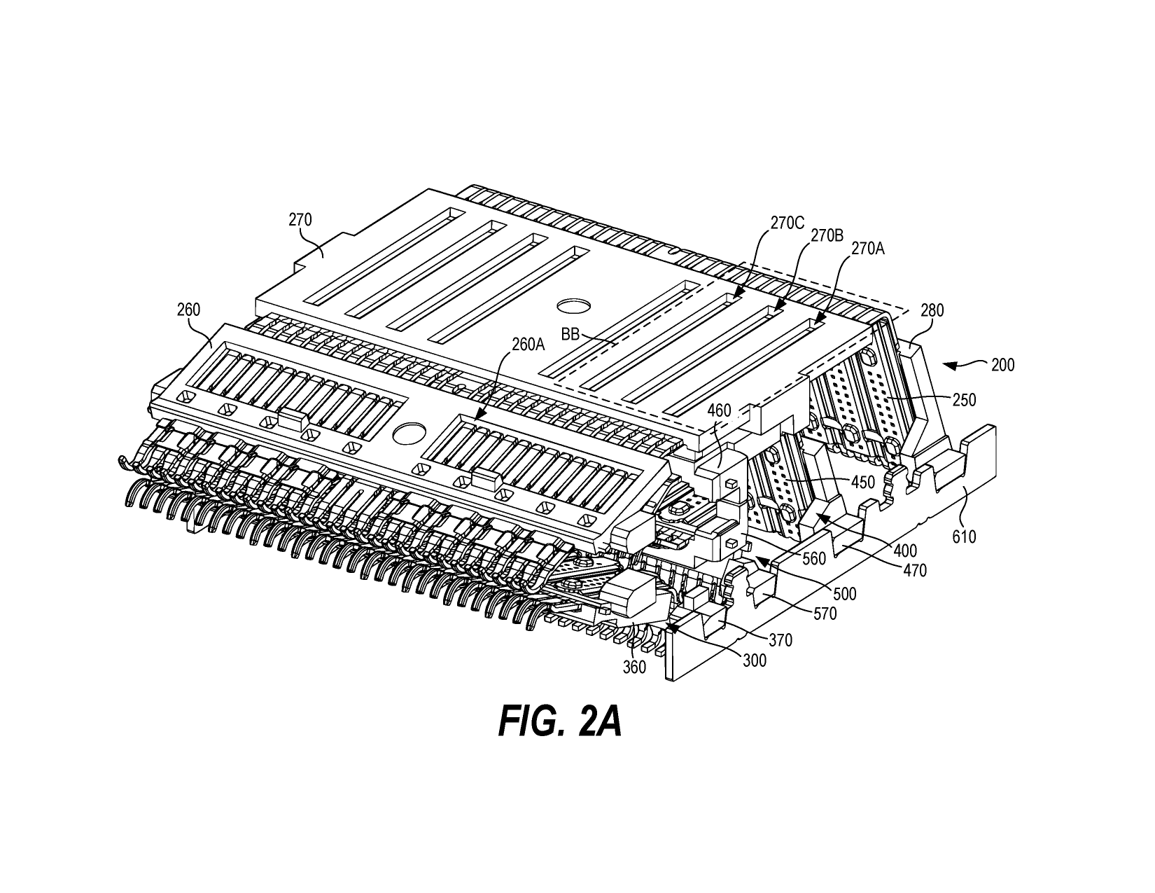

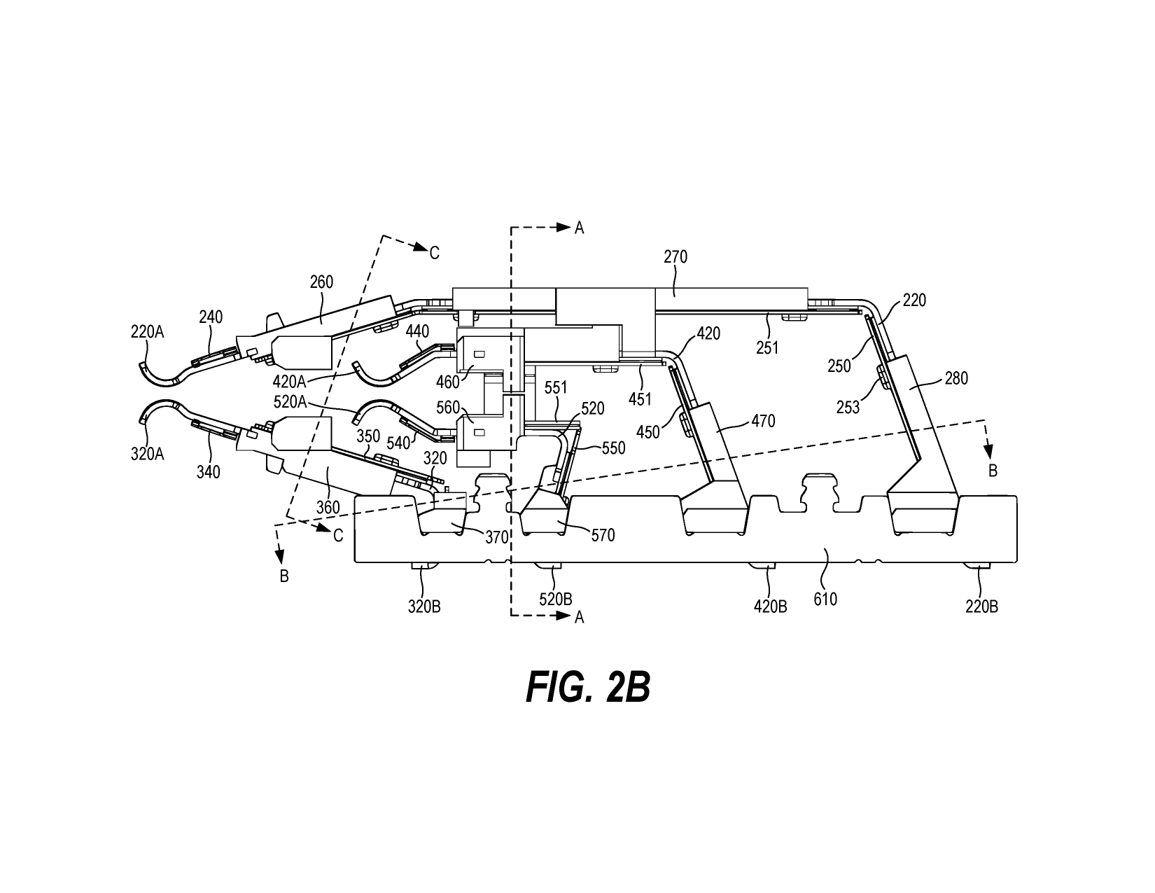

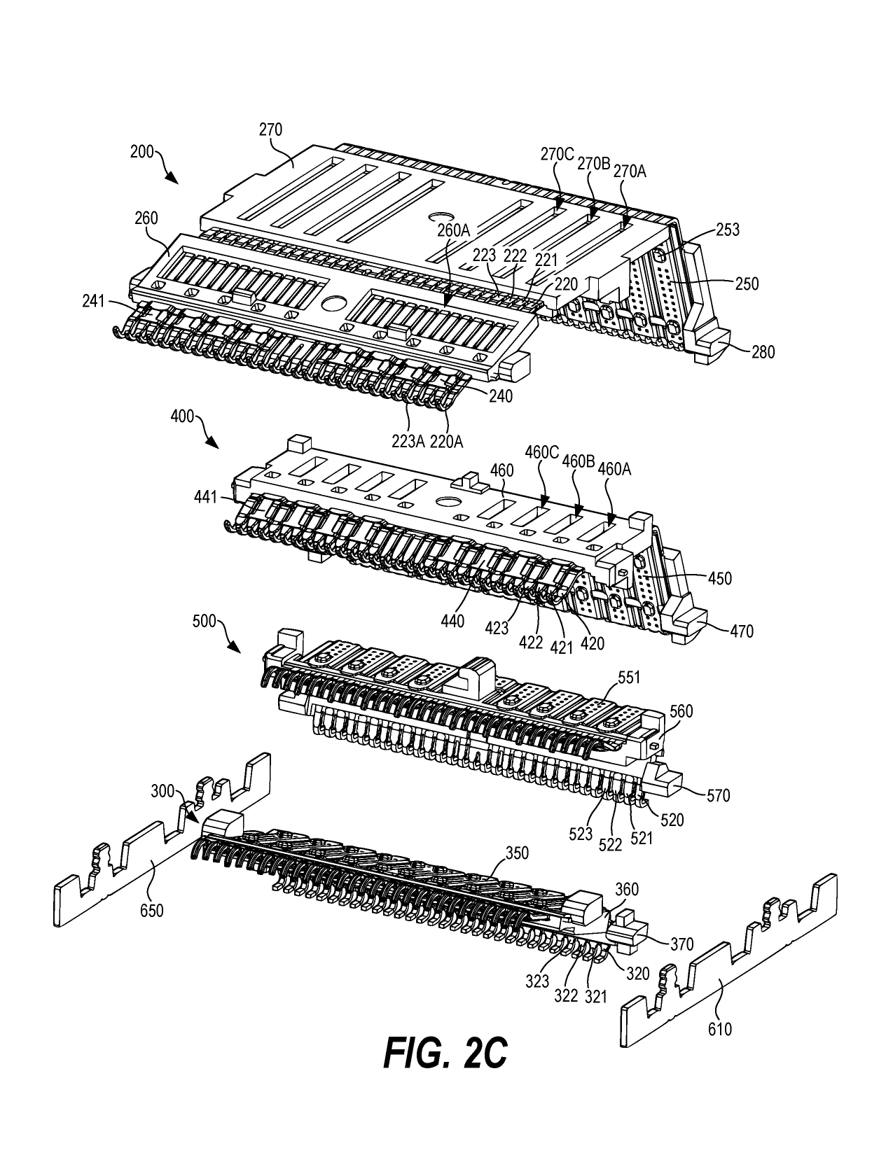

As shown in FIG. 1, the connector 10 includes a housing 100 and rows 210 and 310 of signal and ground terminal conductors. Additional rows of signal and ground terminal conductors are positioned in the connector 10 behind the rows 210 and 310. The signal and ground terminal conductors in the rows have contact tips, which are located within the front port opening 12. The wafer assemblies supporting the rows are positioned and secured within the housing 100. The wafer assemblies are described in further detail below with reference to FIGS. 2A-2C.

The housing 100 can be formed from a plastic, polymer, or other insulating material, such as liquid crystal polymer (LCP), polyethylene (PE), polytetrafluoroethylene (PTFE), fluoropolymer, or other plastic or insulating material(s). The housing 100 can also be formed from metal or combinations of insulating and conductive materials in some cases. The housing 100 can be formed using any suitable additive or subtractive manufacturing techniques, including molding, injection molding, printing, and other techniques.

The housing 100 include a front port 110, a bottom mounting surface 120, and mounting posts 122 and 124, among other features. The connector 10 can be configured to receive the PCB-style tip of an SFP transceiver module, as one example, although the connector 10 can also receive other types of board card edge interfaces. When the PCB-style tip is inserted into the front port opening 12, the rows 210 and 310 of signal and ground terminal conductors, among others in the connector 10, will contact, wipe against, and make electrical contact with contact pads on top and bottom surfaces of a PCB-style tip of an SFP module, in one example application.

The electrical characteristics and shielding for the signal terminal conductors in the rows of terminal conductors can be particularly important in the connector 10. Suitable electromagnetic interference (EMI) shielding can be necessary to meet the electrical characteristic and signal integrity specifications of emerging industry standards, as one example among other reasons. The impedances along the lengths of the signal terminal conductors can also be important in the connector 10, including within the front port opening 12, at the terminal foot 13, and inside the body of the housing 100 between the front port opening 12 and the foot 13. Each wafer assembly in the connector 10 is thus carefully designed to maintain shielding and tailor the impedance and related electrical characteristics of the signal terminal conductors.

According to aspects of the embodiments described in further detail below, each of the wafer assemblies in the connector 10 includes one or more dielectric inserts. The dielectric inserts support the pairs of signal terminal conductors (also “signal terminals”) between the front port opening 12 and the foot 13 of the connector. One or more dielectric inserts in the wafer assemblies can extend over and contact top surface regions of signal terminal pairs in the wafer assemblies. The dielectric inserts can also include windows along lengths of pairs of signal terminals in the connector 10, along edges where contact is established between the dielectric inserts and the signal terminals. The dielectric inserts described herein can help to reduce crosstalk and other undesirable effects, including FEXT, resonant peaks, and other effects, while reducing the cost and complexity required by other approaches, such as using costly conductive plastic and complicated metallic shielding networks. The dielectric inserts described herein are designed for fabrication using existing over-molding manufacturing processes by forming and positioning the dielectric inserts to strategically mitigate FEXT without the need for additional components or manufacturing process steps. The dielectric inserts help to reduce FEXT without adversely impacting impedance, return loss, or insertion loss in the connector 10, among other benefits.

FIG. 2A illustrates a perspective view of the wafer assemblies 200, 300, 400, and 500 of the connector 10 shown in FIG. 1, with the housing 100 of the connector 10 omitted from view, according to various embodiments of the present disclosure. FIG. 2B illustrates a side view of the wafer assemblies 200, 300, 400, and 500 shown in FIG. 2A, and FIG. 2C illustrates a perspective view of the wafer assemblies 200, 300, 400, and 500 with parts exploded away from each other. The wafer assembly 200 can be referred to a first upper wafer assembly in the connector 10, and the wafer assembly 300 can be referred to as a first lower wafer assembly in the connector 10. The wafer assembly 400 can be referred to a second upper wafer assembly in the connector 10, and the wafer assembly 500 can be referred to as a second lower wafer assembly in the connector 10. The wafer assemblies 200, 300, 400, and 500 are depicted as representative examples in FIGS. 2A-2C and can vary in size, shape, and other aspects as compared to that shown. The concepts described herein can also be extended to other wafer assemblies in other connectors.

The wafer assemblies 200, 300, 400, and 500 include signal terminal conductors (also “signal terminals”) for the communication of high-speed data signals and low-speed data signals through the connector 10. The signal terminals of the upper wafer assemblies 200 and 400 can transfer data from the front port opening 12 to the terminal foot 13 of the connector 10 (e.g., be used for data reception), and the signal terminals of the lower wafer assemblies 300 and 500 can transfer data from the terminal foot 13 to the front port opening 12 of the connector 10 (e.g., be used for data transmission). However, the signal terminal conductors in the wafer assemblies 200, 300, 400, and 500 are not limited to any particular direction of data transfer and can be used in any combination of data reception and transmission, between the front port opening 12 and the terminal foot 13 of the connector 10. The wafer assemblies 200, 300, 400, and 500 also include ground terminal conductors (also “ground terminals”), which extend between pairs of the signal terminals. The wafer assemblies 200, 300, 400, and 500 can also include terminal conductors for the transfer of power through the connector 10.

Referring to FIG. 2C, the wafer assembly 200 includes signal terminal conductors 221 and 222 (also “signal terminals 221 and 222”), among others, and ground terminal conductors 220 and 223 (also “ground terminals 220 and 223”), among others. The signal terminal conductors 221 and 222 and the ground terminal conductors 220 and 223 can collectively be referred to as terminals 220-223. The ground terminal 220 is positioned on one side of the pair of signal terminals 221 and 222, and the ground terminal 223 is positioned on another side of the pair of signal terminals 221 and 222. The wafer assembly 200 also includes dielectric inserts 260, 270, and 280, flexible shields 240 and 241, and rigid shields 250 and 251 (see FIGS. 2B and 2C), among possibly other components.

The terminals 220-223, among others in the wafer assembly 200, can be formed (e.g., stamped, sheared, bent, and otherwise formed) from a flat sheet of metal or other conductive material. In some cases, the sheet of metal can be plated with one or more plating metals. The terminals 220-223 can be formed in a row, extending alongside each other, at the same time from a single sheet of metal in one example. Each of the terminals 220-223, among others in the wafer assembly 200, includes a lead or tip contact at one distal end (i.e., positioned in the front port opening 12 of the connector 10, as shown in FIG. 1), a tail contact at another distal end (i.e., positioned at the terminal foot 13), and a terminal conductor body including one or more bends between the tip contact and the tail contact. For example, as shown in FIGS. 2B and 2C, the ground terminal conductors 220 and 223 include tip contacts 220A and 223A, and the ground terminal conductor 220 includes a tail contact 220B. A length of each terminal in the wafer assembly 200 can be measured from the tip to the tail contact of the terminal. The tail contacts of the terminals in the wafer assembly 200 can be formed as SMT tail contacts, as in the example shown, as through-hole (e.g., eye-of-needle) tail contacts, or as other types of tail contacts.

The dielectric inserts 260, 270, and 280 can be formed by injection molding. In one example, the terminal conductors 220-223, among others in the wafer assembly 200, can be arranged and positioned in a mold. The dielectric inserts 260, 270, and 280 can then be formed by the injection of a plastic, such as LCP, PE, PTFE, fluoropolymer, or other plastic or insulating material(s), into the mold. The insulating material can flow around certain regions and surfaces of the terminal conductors 220-223, among others in the wafer assembly 200, within the mold, to form the dielectric inserts 260, 270, and 280 at the locations shown. When formed, the dielectric inserts 260, 270, and 280 can extend over and contact top surface regions of signal terminal pairs in the wafer assembly 200. The dielectric inserts can also include windows along lengths of pairs of the signal terminals in the connector 10, as described below.

The dielectric inserts 260, 270, and 280 serve a number of purposes in the wafer assembly 200. The dielectric inserts 260, 270, and 280 secure the terminal conductors 220-223, among others in the wafer assembly 200, in place relative to each other. The dielectric inserts 260, 270, and 280 also electrically isolate the signal terminal conductors in the wafer assembly 200 from each other. When formed, the insulating material of the dielectric inserts 260, 270, and 280 can also flow through, or otherwise be inserted through, openings or apertures in the rigid shields 250 and 251. A heat staking process can then be used to form staking caps of the dielectric inserts 260, 270, and 280 on one side of the rigid shields 250 and 251, to hold and secure the wafer assembly 200 together. An example staking cap 253 is referenced in FIGS. 2B and 2C. The staking caps secure the dielectric inserts 260, 270, and 280, along with the terminal conductors of the wafer assembly 200, with the rigid shields 250 and 251. Thus, when formed, the dielectric inserts 260, 270, and 280 secure the terminal conductors 220-223, among others in the wafer assembly 200, in position with respect to the rigid shields 250 and 251 and electrically isolate the signal terminal conductors in the wafer assembly 200 from each other and from the rigid shields 250 and 251.

Referring again to FIG. 2C, the wafer assembly 300 includes signal terminal conductors 321 and 322 (also “signal terminals 321 and 322”), among others, and ground terminal conductors 320 and 323 (also “ground terminals 320 and 323”), among others. The signal terminal conductors 321 and 322 and the ground terminal conductors 320 and 323 can collectively be referred to as terminals 320-323. The ground terminal 320 is positioned on one side of the pair of signal terminals 321 and 322, and the ground terminal 323 is positioned on another side of the pair of signal terminals 321 and 322. The wafer assembly 300 also includes dielectric inserts 360 and 370, flexible shields, such as the flexible shield 340 (see FIG. 2B), and a rigid shield 350 (see FIG. 2B), among possibly other components.

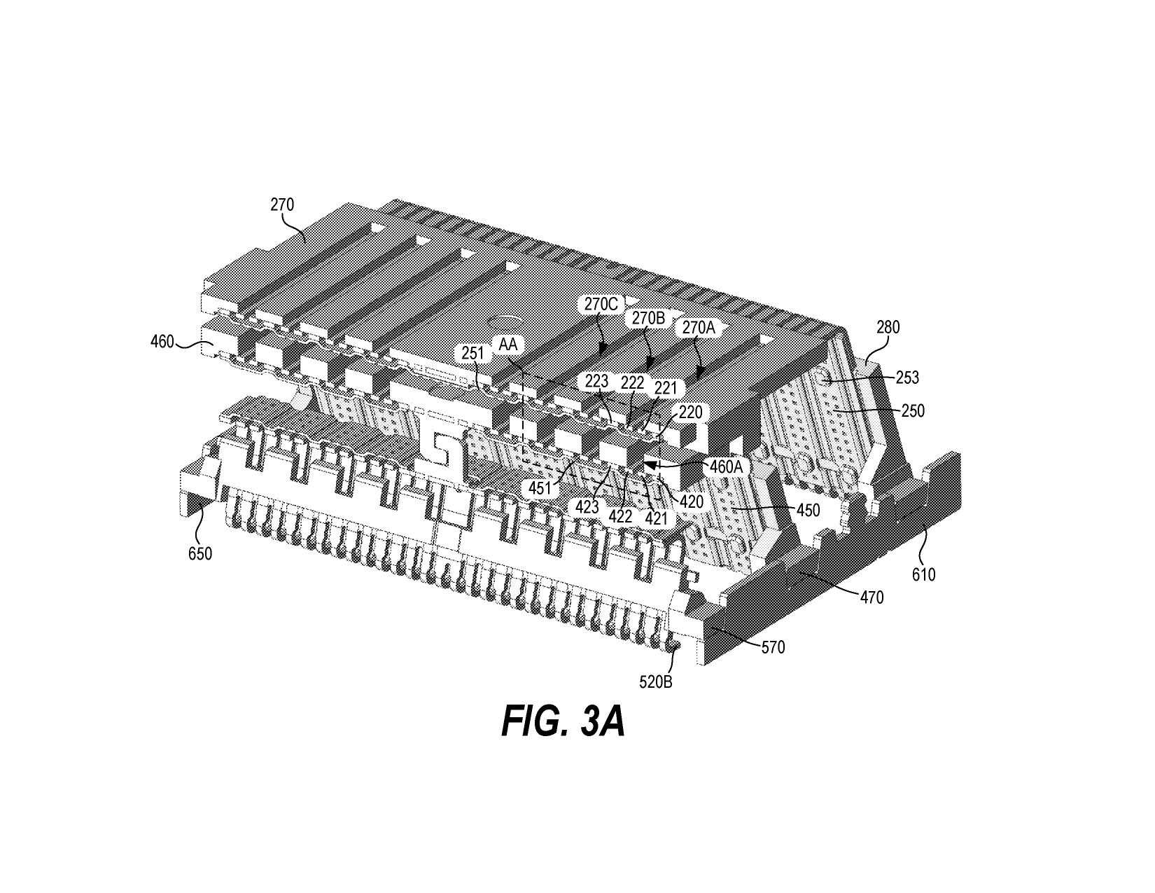

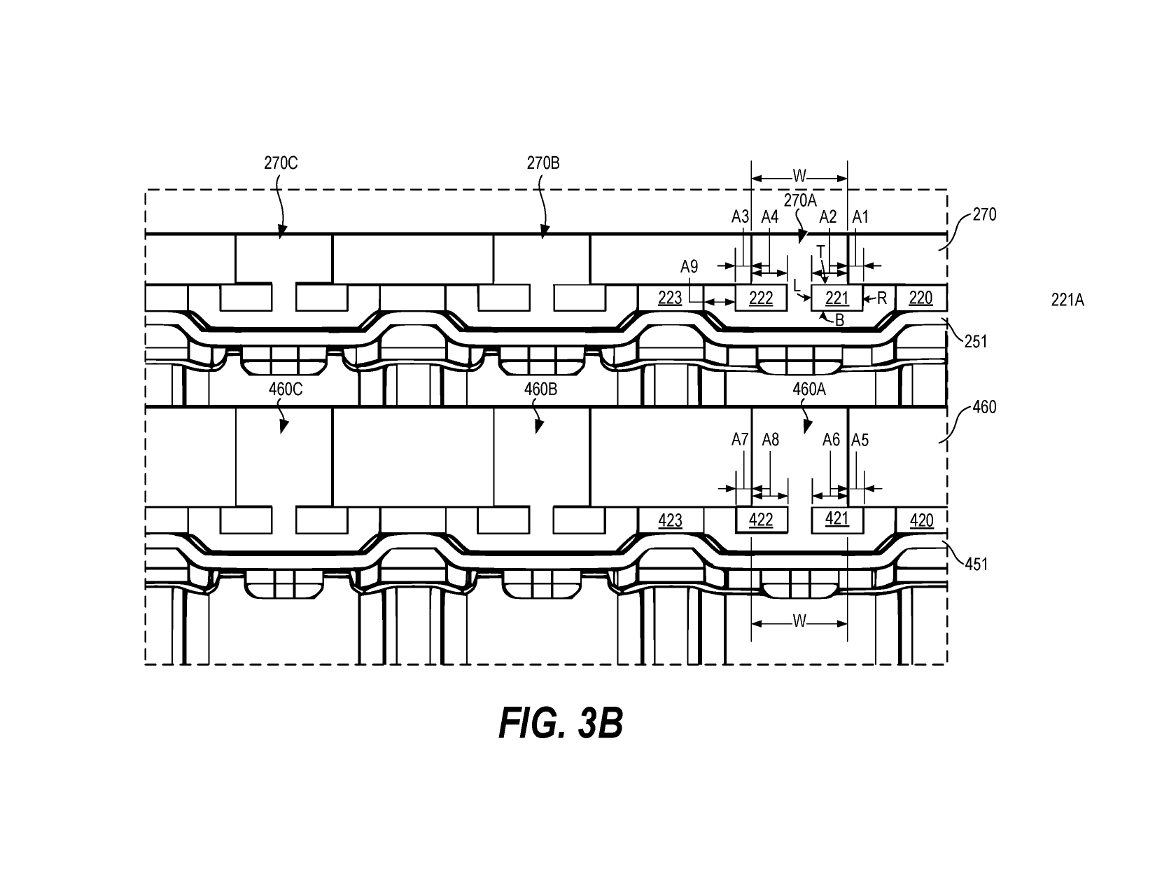

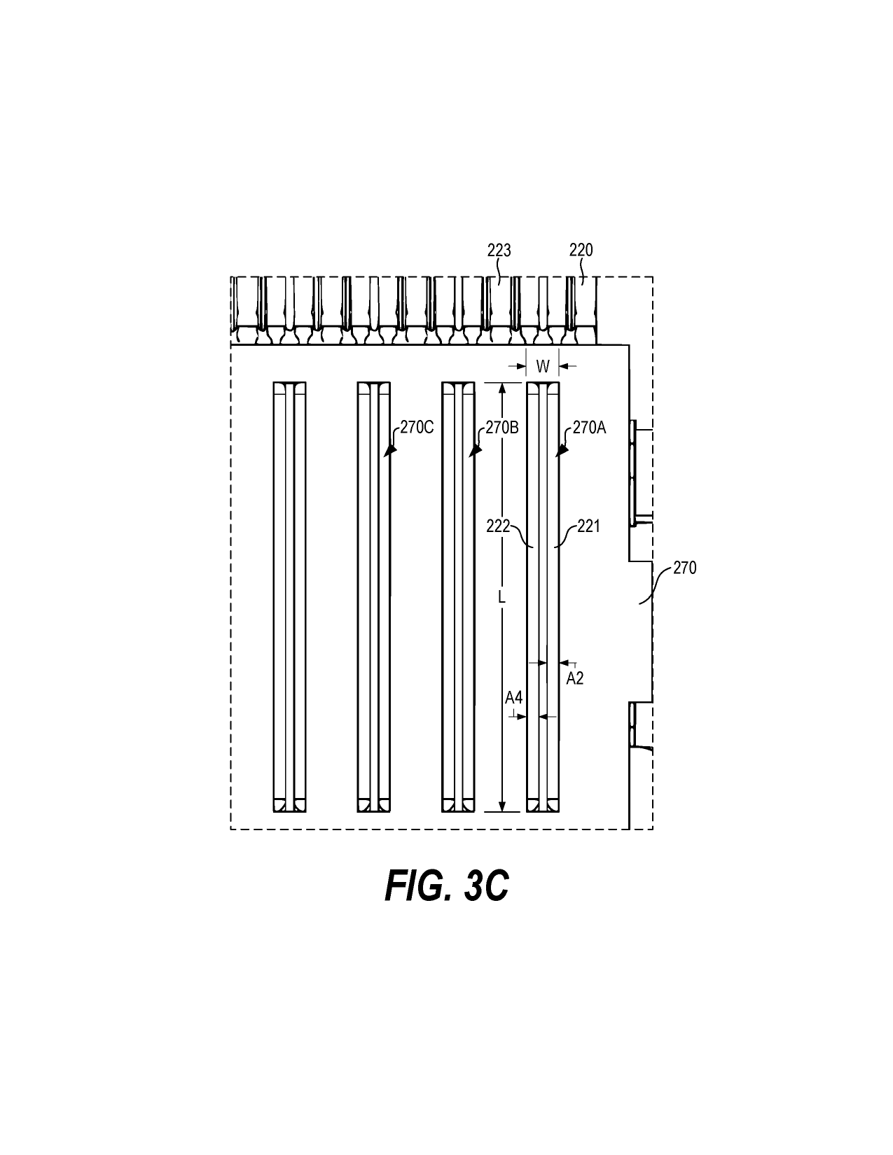

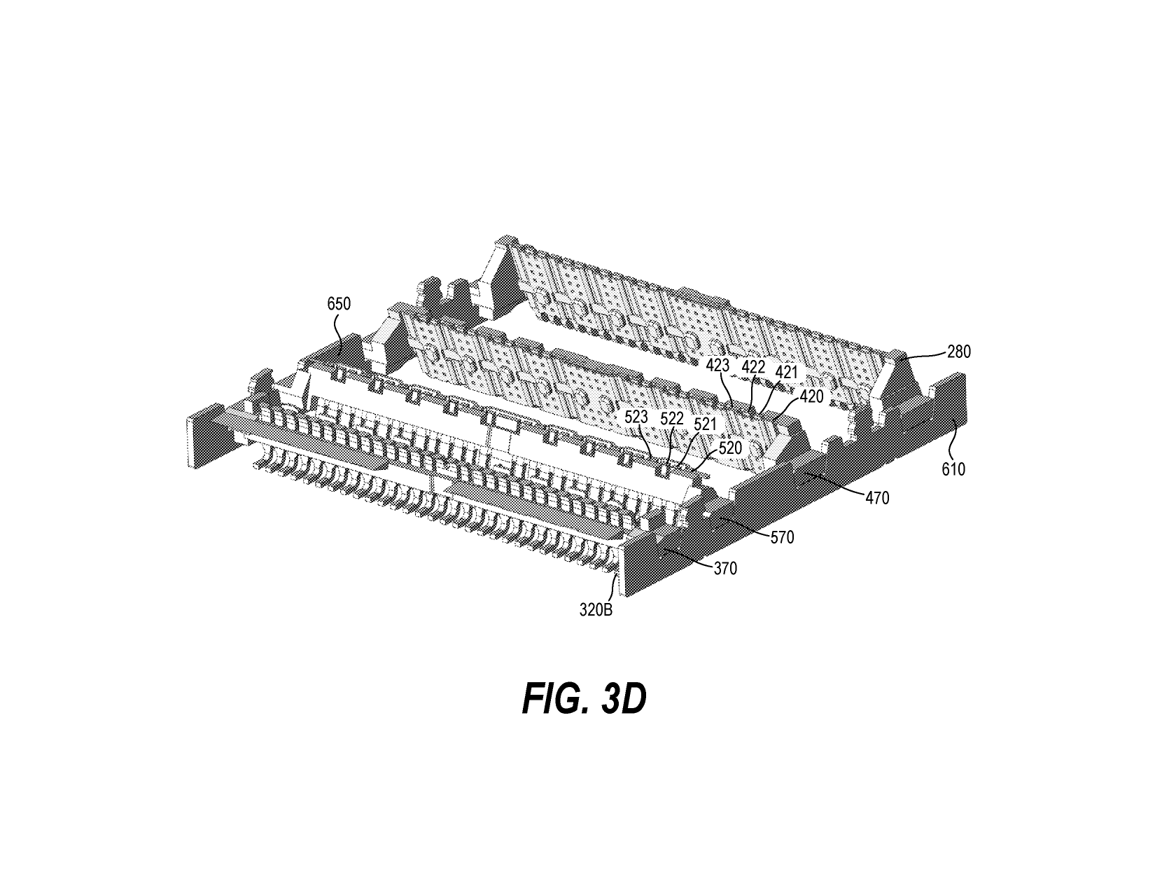

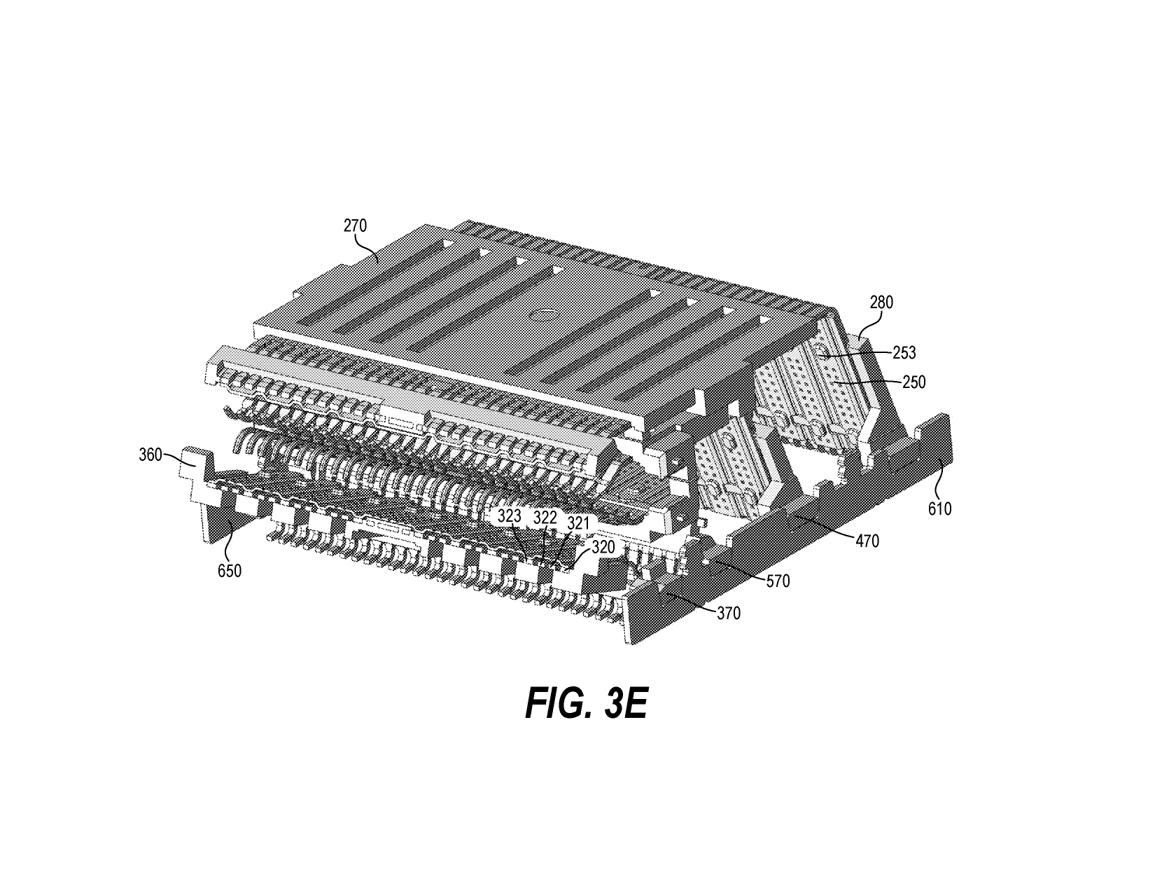

The terminals 320-323, among others in the wafer assembly 300, can be formed from a flat sheet of metal or other conductive material. In some cases, the sheet of metal can be plated with one or more plating metals. The terminals 320-323 can be formed in a row, extending alongside each other, at the same time from a single sheet of metal in one example. Each of the terminals 320-323, among others in the wafer assembly 300, includes a lead or tip contact at one distal end (i.e., positioned in the front port opening 12 of the connector 10, as shown in FIG. 1), a tail contact at another distal end (i.e., positioned at the terminal foot 13), and a terminal conductor body including one or more bends between the tip contact and the tail contact. For example, as shown in FIG. 2B, the ground terminal conductor 320 includes a tip contact 320A and a tail contact 320B (see FIG. 3D). A length of each terminal in the wafer assembly 300 can be measured from the tip contact to the tail contact of the terminal. The tail contacts of the terminals in the wafer assembly 300 can be formed as SMT tail contacts, as in the example shown, as through-hole (e.g., eye-of-needle) tail contacts, or as other types of tail contacts.

The dielectric inserts 360 and 370 can be formed by injection molding. In one example, the terminal conductors 320-323, among others in the wafer assembly 300, can be arranged and positioned in a mold. The dielectric inserts 360 and 370 can then be formed by the injection of a plastic, such as LCP, PE, PTFE, fluoropolymer, or other plastic or insulating material(s), into the mold. The insulating material can flow around certain regions and surfaces of the terminal conductors 320-323, among others in the wafer assembly 300, within the mold, to form the dielectric inserts 360 and 370 at the locations shown. When formed, the dielectric inserts 360 and 370 can extend over and contact surface regions of signal terminal pairs in the wafer assembly 300.

The dielectric inserts 360 and 370 serve a number of purposes in the wafer assembly 300. The dielectric inserts 360 and 370 secure the terminal conductors 320-323, among others in the wafer assembly 300, in place relative to each other. The dielectric inserts 360 and 370 also electrically isolate the signal terminal conductors in the wafer assembly 300 from each other. When formed, the insulating material of the dielectric inserts 360 and 370 can also flow through, or otherwise be inserted through, openings or apertures in the rigid shield 350. A heat staking process can then be used to form staking caps of the dielectric inserts 360 and 370 on one side of the rigid shield 350, to hold and secure the wafer assembly 300 together.

Referring again to FIG. 2C, the wafer assembly 400 includes signal terminal conductors 421 and 422 (also “signal terminals 421 and 422”), among others, and ground terminal conductors 420 and 423 (also “ground terminals 420 and 423”), among others. The signal terminal conductors 421 and 422 and the ground terminal conductors 420 and 423 can collectively be referred to as terminals 420-423. The ground terminal 420 is positioned on one side of the pair of signal terminals 421 and 422, and the ground terminal 423 is positioned on another side of the pair of signal terminals 421 and 422. The wafer assembly 400 also includes dielectric inserts 460 and 470, flexible shields 440 and 441, and rigid shields 450 and 451, among possibly other components.

The terminals 420-423, among others in the wafer assembly 400, can be formed from a flat sheet of metal or other conductive material. In some cases, the sheet of metal can be plated with one or more plating metals. The terminals 420-423 can be formed in a row, extending alongside each other, at the same time from a single sheet of metal in one example. Each of the terminals 420-423, among others in the wafer assembly 400, includes a lead or tip contact at one distal end (i.e., positioned in the front port opening 12 of the connector 10, as shown in FIG. 1), a tail contact at another distal end (i.e., positioned at the terminal foot 13), and a terminal conductor body including one or more bends between the tip contact and the tail contact. For example, as shown in FIG. 2B, the ground terminal conductor 420 includes a tip contact 420A and a tail contact 420B. The tail contacts of the terminals in the wafer assembly 400 can be formed as SMT tail contacts, as in the example shown, as through-hole (e.g., eye-of-needle) tail contacts, or as other types of tail contacts.

The dielectric inserts 460 and 470 can be formed by injection molding. In one example, the terminal conductors 420-423, among others in the wafer assembly 400, can be arranged and positioned in a mold. The dielectric inserts 460 and 470 can then be formed by the injection of a plastic, such as LCP, PE, PTFE, fluoropolymer, or other plastic or insulating material(s), into the mold. The insulating material can flow around certain regions and surfaces of the terminal conductors 420-423, among others in the wafer assembly 400, within the mold, to form the dielectric inserts 460 and 470 at the locations shown. When formed, the dielectric inserts 460 and 470 can extend over and contact surface regions of signal terminal pairs in the wafer assembly 400.

The dielectric inserts 460 and 470 serve a number of purposes in the wafer assembly 400. The dielectric inserts 460 and 470 secure the terminal conductors 420-423, among others in the wafer assembly 400, in place relative to each other. The dielectric inserts 460 and 470 also electrically isolate the signal terminal conductors in the wafer assembly 400 from each other. When formed, the insulating material of the dielectric inserts 460 and 470 can also flow through, or otherwise be inserted through, openings or apertures in the rigid shields 450 and 451. A heat staking process can then be used to form staking caps of the dielectric inserts 460 and 470 on one side of the rigid shields 450 and 451, to hold and secure the wafer assembly 400 together.

Referring again to FIG. 2C, the wafer assembly 500 includes signal terminal conductors 521 and 522 (also “signal terminals 521 and 522”), among others, and ground terminal conductors 520 and 523 (also “ground terminals 520 and 523”), among others. The signal terminal conductors 521 and 522 and the ground terminal conductors 520 and 523 can collectively be referred to as terminals 520-523. The ground terminal 520 is positioned on one side of the pair of signal terminals 521 and 522, and the ground terminal 523 is positioned on another side of the pair of signal terminals 521 and 522. The wafer assembly 500 also includes dielectric inserts 560 and 570, flexible shields, such as the flexible shield 540 (see FIG. 2B), and rigid shields 550 and 551, among possibly other components.

The terminals 520-523, among others in the wafer assembly 500, can be formed from a flat sheet of metal or other conductive material. In some cases, the sheet of metal can be plated with one or more plating metals. The terminals 520-523 can be formed in a row, extending alongside each other, at the same time from a single sheet of metal in one example. Each of the terminals 520-523, among others in the wafer assembly 500, includes a lead or tip contact at one distal end (i.e., positioned in the front port opening 12 of the connector 10, as shown in FIG. 1), a tail contact at another distal end (i.e., positioned at the terminal foot 13), and a terminal conductor body including one or more bends between the tip contact and the tail contact. For example, as shown in FIG. 2B, the ground terminal conductor 520 includes a tip contact 520A and a tail contact 520B. The tail contacts of the terminals in the wafer assembly 500 can be formed as SMT tail contacts, as in the example shown, as through-hole (e.g., eye-of-needle) tail contacts, or as other types of tail contacts.

The dielectric inserts 560 and 570 can be formed by injection molding. In one example, the terminal conductors 520-523, among others in the wafer assembly 500, can be arranged and positioned in a mold. The dielectric inserts 560 and 570 can then be formed by the injection of a plastic, such as LCP, PE, PTFE, fluoropolymer, or other plastic or insulating material(s), into the mold. The insulating material can flow around certain regions and surfaces of the terminal conductors 520-523, among others in the wafer assembly 500, within the mold, to form the dielectric inserts 560 and 570 at the locations shown. When formed, the dielectric inserts 560 and 570 can extend over and contact surface regions of signal terminal pairs in the wafer assembly 500.

The dielectric inserts 560 and 570 serve a number of purposes in the wafer assembly 500. The dielectric inserts 560 and 570 secure the terminal conductors 520-523, among others in the wafer assembly 500, in place relative to each other. The dielectric inserts 560 and 570 also electrically isolate the signal terminal conductors in the wafer assembly 500 from each other. When formed, the insulating material of the dielectric inserts 560 and 570 can also flow through, or otherwise be inserted through, openings or apertures in the rigid shields 550 and 551. A heat staking process can then be used to form staking caps of the dielectric inserts 560 and 570 on one side of the rigid shields 550 and 551, to hold and secure the wafer assembly 500 together.

The connector 10 also includes the wafer interlock rails 610 and 650. The wafer interlock rails 610 and 650 are rigid rails and can be stamped, sheared, bent, or otherwise formed from a flat sheet of metal in one example, although the wafer interlock rails 610 and 650 can be formed from plastic or other materials in some cases. The wafer interlock rails 610 and 650 include wafer insert seats, and the bottom ends of the dielectric inserts 280, 370, 470, and 570 can be positioned secured into the wafer insert seats. The dielectric inserts 280, 370, 470, and 570 can be secured in the wafer insert seats of the wafer interlock rails 610 and 650 using mechanical interferences, snap or friction fits, adhesives, mechanical fasteners, or other approaches or combinations thereof. The wafer interlock rails 610 and 650 and the wafer assemblies 200, 300, 400, and 500 can be inserted into and secured within the housing 100 of the connector 10, when the connector 10 is assembled.

As noted above, one or more of the dielectric inserts in the wafer assemblies 200, 300, 400, and 500 can extend over and contact top surface regions of signal terminals in the wafer assemblies 200, 300, 400, and 500. The dielectric inserts can also include windows along lengths of pairs of signal terminals in the connector 10, along edges where contact is established between the dielectric inserts and the signal terminals. Referring to FIG. 2C for an example, the dielectric insert 270 extends over and contacts at least one surface region of each of the signal terminals 221 and 222 in the wafer assembly 200, over a least a length of the signal terminals 221 and 222. The dielectric insert 270 includes a window 270A that extends along a portion of the full length of the signal terminals 221 and 222. The dielectric insert 270 contacts a part or a portion of at least one surface of the signal terminals 221 and 222, such as a portion of a top surface of each of the signal terminals 221 and 222, within the window 270A. The dielectric insert 270 also contacts surface regions of other pairs of signal conductors in the wafer assembly 200, and the dielectric insert 270 includes other windows, such as the windows 270B and 270C, among others.

As another example, the dielectric insert 460 of the wafer assembly 400 extends over and contacts at least one surface region of each of the signal terminals 421 and 422 in the wafer assembly 400, over a least a length of the signal terminals 421 and 422. The dielectric insert 460 includes a window 460A that extends along a portion of the full length of the signal terminals 421 and 422. The dielectric insert 460 contacts a part or a portion of the signal terminals 421 and 422, such as a portion of a top surface of each of the signal terminals 421 and 422, within the window 460A. The dielectric insert 460 also contacts top surface regions of other pairs of signal conductors in the wafer assembly 400, and the dielectric insert 460 includes other windows, such as the windows 460B and 460C, among others. Other dielectric inserts in the wafer assemblies 200, 300, 400, and 500 can be designed in a similar way.

The extent of contact between surface regions of the signal terminals in the wafer assemblies 200, 300, 400, and 500 and one or more of the dielectric inserts 260, 270, 280, 360, 370, 460, 470, 560, and 570 can be tailored to reduce FEXT, resonant peaks, and other undesirable effects in the connector 10. The size and position of the windows in the dielectric inserts 260, 270, 280, 360, 370, 460, 470, 560, and 570 can also be tailored for a similar purpose. The dielectric inserts 260, 270, 280, 360, 370, 460, 470, 560, and 570 help to reduce FEXT without adversely impacting impedance, return loss, or insertion loss in the connector 10, among other benefits. These and other aspects of the embodiments are described below.

FIG. 3A illustrates the sectional view designated A-A in FIG. 2B. As shown in FIG. 3A, the dielectric insert 270 contacts top surface regions of the signal terminals 221 and 222 over a length of the window 270A. The top surface regions of the signal terminals 221 and 222 that are covered by the dielectric insert 270 are less than the full top surface areas of the signal terminals 221 and 222 over the length of the window 270A. The dielectric insert 270 also contacts and covers the top surfaces of the ground terminals 220 and 223 over the length of the window 270A. As also shown in FIG. 3A, the dielectric insert 460 contacts top surface regions of the signal terminals 421 and 422 over a length of a window 460A. The top surface regions of the signal terminals 421 and 422 that are covered by the dielectric insert 460 are less than the full top surface areas of the signal terminals 421 and 422 over the length of the window 460A. The dielectric insert 460 also contacts and covers the top surfaces of the ground terminals 420 and 423 over the length of the window 460A.

FIG. 3B illustrates the detail view designated AA in FIG. 3A, and FIG. 3C illustrates the detail view designated BB in FIG. 2A. More particularly, FIG. 3B illustrates the detail view AA of the sectional view shown in FIG. 3A. Thus, FIG. 3B shows a sectional view of the terminal conductors 220-223, the dielectric insert 270, and the rigid shield 251 of the wafer assembly 200. FIG. 3B also shows a sectional view of the terminal conductors 420-423, the dielectric insert 460, and the rigid shield 451 of the wafer assembly 400. FIG. 3C illustrates a top-down view of the region the wafer assembly 200 designated BB in FIG. 2A.

Each of the terminal conductors 220-223, among others in the connector 10, includes a top surface, a bottom surface, a left side surface, and a right side surface. For example, the terminal conductor 221 in FIG. 3B includes a top surface “T” that extends substantially parallel to a bottom surface “B” and a left side surface “L” that extends substantially parallel to a right side surface “R”. The right and left side surfaces of the terminal conductor 221 can be formed when the terminal conductor 221 is sheared or cut out from a flat sheet of metal or other conductive material, as described herein. Thus, the right and left side surfaces of the terminal conductor 221, among other terminal conductors in the connector 10, can be referred to as cut faces, cut edges, or cut surfaces. The top and bottom surfaces of the terminal conductor 221 are original surfaces of the flat sheet of metal from which the terminal conductor 221 is cut out from. Thus, the top and bottom surfaces of the terminal conductor 221, among other terminal conductors in the connector 10, can be referred to as rolled faces, broadside faces, or rolled or broadside surfaces. The other terminal conductors in the connector 10 include similar surfaces formed and arranged in a similar way.

As shown in FIG. 3B, the dielectric insert 270 covers and contacts top surface regions of the signal terminals 221 and 222, over the length “L” (see FIG. 3C) of the window 270A, but not the entire top surfaces of the signal terminals 221 and 222 along the length “L”. More particularly, the dielectric insert 270 covers a portion “A1” of the width of the top surface of the signal terminal 221, but the dielectric insert 270 does not cover the portion “A2” of the width of the top surface of the signal terminal 221 over the width “W” of the window 270A. The dielectric insert 270 covers the portion “A1” but not the portion “A2” along the length “L” (see FIG. 3C) of the window 270A and the signal terminal 221. Thus, the dielectric insert 270 does not contact or cover the portion “A2” of the top surface of the signal terminal 221, meaning that the portion “A2” of the top surface of the signal terminal 221 is exposed and visible within the width “W” of the window 270A, as shown in FIG. 3C. The dielectric insert 270 also covers a portion “A3” of the width of the top surface of the signal terminal 222, but the dielectric insert 270 does not cover the portion “A4” of the width of the top surface of the signal terminal 222 over the width “W” of the window 270A. The dielectric insert 270 covers the portion “A3” but not the portion “A4” along the length “L” (see FIG. 3C) of the window 270A and the signal terminal 222. Thus, the portion “A4” of the top surface of the signal terminal 221 is exposed and visible within the width “W” of the window 270A as shown in FIG. 3C.

The bottom, right, and left side surfaces of the signal terminals 221 and 222 are fully exposed and not contacted or covered by the dielectric insert 270 or any other dielectric materials in the example shown in FIG. 3B. The bottom surfaces of the signal terminals 221 and 222 face the rigid shield 251. An open gap “A9” extends between the left surface of the signal terminal 222 and the ground terminal 223, and a similar open gap extends between the right surface of signal terminal 221 and the ground terminal 220. In other examples, however, the dielectric insert 270 can contact portions or regions of only the bottom surface of the signal terminals 221 and 222, portions or regions of only side surfaces of the signal terminals 221 and 222, or portions of a side surface and a top or bottom surface of the signal terminals 221 and 222. In still other examples, the dielectric insert 270 can contact portions of the top and bottom surfaces of the signal terminals 221 and 222, the entire left side surface of the terminal 222, and the entire right side surface of the signal terminal 221. In any case, at least a portion of at least one surface (i.e., at least one of the top, bottom, right, or left surface) of the terminals 221 and 222 is exposed over the length “L” of the window 270A.

The covered-to-uncovered ratio “A1”/“A2” of the signal terminal 221 within the window 270A can vary among the embodiments. The covered-to-uncovered ratio “A3”/“A4” of the signal terminal 222 within the window 270A can also vary among the embodiments. The ratio “A1”/“A2” is greater than zero and equal to or less than 50% (i.e., 0.5) in preferred examples. As other examples, the ratio “A1”/“A2” can be greater than zero and equal to or less than 5%, 10%, 15%, 20%, 25%, 30%, 35%, 40%, 45%, or 50%. The ratio “A1”/“A2” can also be equal to or greater than 50% but less than 100%. As other examples, the ratio “A1”/“A2” can be equal to or greater than 50% but less than 55%, 60%, 65%, 70%, 75%, 80%, 85%, 90%, or 95%. The ratio “A1”/“A2” can be tailored to reduce FEXT, resonant peaks, and other undesirable effects in the connector 10. The ratio “A3”/“A4” is also greater than zero and equal to or less than 50% (i.e., 0.5) in preferred examples. As other examples, the ratio “A3”/“A4” can be greater than zero and equal to or less than 5%, 10%, 15%, 20%, 25%, 30%, 35%, 40%, 45%, or 50%. The ratio “A3”/“A4” can also be equal to or greater than 50% but less than 100%. As other examples, the ratio “A3”/“A4” can be equal to or greater than 50% but less than 55%, 60%, 65%, 70%, 75%, 80%, 85%, 90%, or 95%. The ratio “A3”/“A4” can be tailored to reduce FEXT, resonant peaks, and other undesirable effects in the connector 10. The ratio of “A1”/“A2” and the ratio of “A3”/“A4” can be the same as each other in some preferred examples, but the ratio of “A1”/“A2” can also be different than the ratio of “A3”/“A4” in other cases. The width “W” of the window 270A will vary based on the ratio “A1”/“A2” and the ratio “A3”/“A4”.

The length “L” of the window 270A shown in FIG. 3C can be tailored to reduce FEXT, resonant peaks, and other undesirable effects in the connector 10 and can vary among the embodiments. The length “L” of the window 270A is a portion of the full length of each terminal conductor in the wafer assembly 200 and, more particularly, a portion of the full lengths from the tip contact to tail contacts of the signal terminals 221 and 222. The length “L” of the window 270A can be at least 1 mm, 1.5 mm, 2 mm, 2.5 mm, 3 mm, or more.

As also shown in FIG. 3B, the dielectric insert 270 entirely covers the top surfaces of the ground terminals 220 and 223. Stated differently, the dielectric insert 270 entirely covers the top surfaces of each of the ground terminals 220 and 223 along the length “L” of the window 270A and, further, over an entire length of the dielectric insert 270 itself. The bottom surfaces of the ground terminals 220 and 223 make electrical contact with the rigid shield 251 over the full length of the dielectric insert 270. In a similar way, the dielectric insert 460 entirely covers the top surfaces of the ground terminals 420 and 423, and the bottom surfaces of the ground terminals 420 and 423 make electrical contact with the rigid shield 451.

The dielectric insert 460 covers and contacts top surface regions of the signal terminals 421 and 422, over the length of the window 460A, but not the entire top surfaces of the signal terminals 421 and 422 along the length. More particularly, the dielectric insert 460 covers a portion “A5” of the width of the top surface of the signal terminal 421, but the dielectric insert 460 does not cover the portion “A6” of the width of the top surface of the signal terminal 421 over the width of the window 460A. Thus, the portion “A6” of the top surface of the signal terminal 421 is exposed within the width of the window 460A. The dielectric insert 460 also covers a portion “A7” of the width of the top surface of the signal terminal 422, but the dielectric insert 460 does not cover the portion “A8” of the width of the top surface of the signal terminal 422 over the width of the window 460A. Thus, the portion “A8” of the top surface of the signal terminal 421 is exposed within the width of the window 460A.

The bottom, right, and left side surfaces of the signal terminals 421 and 422 are fully exposed and not contacted or covered by the dielectric insert 460 or any other dielectric materials in the example shown in FIG. 3B. The bottom surfaces of the signal terminals 421 and 422 face the rigid shield 451. An open gap extends between the left surface of the signal terminal 422 and the ground terminal 423, and a similar open gap extends between the right surface of signal terminal 421 and the ground terminal 420. In other examples, however, the dielectric insert 460 can contact portions or regions of only the bottom surface of the signal terminals 421 and 422, portions or regions of only side surfaces of the signal terminals 421 and 422, or portions of a side surface and a top or bottom surface of the signal terminals 421 and 422. In still other examples, the dielectric insert 460 can contact portions of the top and bottom surfaces of the signal terminals 421 and 422, the entire left side surface of the terminal 422, and the entire right side surface of the signal terminal 421. In any case, at least a portion of at least one surface (i.e., at least one of the top, bottom, right, or left surface) of the terminals 421 and 422 is exposed over the length of the window 460A.

The covered-to-uncovered ratio “A5”/“A6” of the signal terminal 421 within the window 460A can vary among the embodiments. The covered-to-uncovered ratio “A7”/“A8” of the signal terminal 422 within the window 460A can also vary among the embodiments. The ratio “A5”/“A6” is greater than zero and equal to or less than 50% (i.e., 0.5) in preferred examples. As other examples, the ratio “A5”/“A6” can be greater than zero and equal to or less than 5%, 10%, 15%, 20%, 25%, 30%, 35%, 40%, 45%, or 50%. The ratio “A5”/“A6” can also be equal to or greater than 50% but less than 100%. As other examples, the ratio “A5”/“A6” can be equal to or greater than 50% but less than 55%, 60%, 65%, 70%, 75%, 80%, 85%, 90%, or 95%. The ratio “A5”/“A6” can be tailored to reduce FEXT, resonant peaks, and other undesirable effects in the connector 10. The ratio “A7”/“A8” is also greater than zero and equal to or less than 50% (i.e., 0.5) in preferred examples. As other examples, the ratio “A7”/“A8” can be greater than zero and equal to or less than 5%, 10%, 15%, 20%, 25%, 30%, 35%, 40%, 45%, or 50%. The ratio “A7”/“A8” can also be equal to or greater than 50% but less than 100%. As other examples, the ratio “A7”/“A8” can be equal to or greater than 50% but less than 55%, 60%, 65%, 70%, 75%, 80%, 85%, 90%, or 95%. The ratio “A7”/“A8” can be tailored to reduce FEXT, resonant peaks, and other undesirable effects in the connector 10. The ratio of “A5”/“A6” and the ratio of “A7”/“A8” can be the same as each other in some preferred examples, but the ratio of “A5”/“A6” can also be different than the ratio of “A7”/“A8” in other cases. The width “W” of the window 460A will vary based on the ratio “A5”/“A6” and the ratio “A7”/“A8”.

The length of the window 460A (i.e., directed into the page of FIG. 3B) can be tailored to reduce FEXT, resonant peaks, and other undesirable effects in the connector 10 and can vary among the embodiments. The length of the window 460A is a portion of the full length of each terminal conductor in the wafer assembly 400 and, more particularly, a portion of the full lengths from the tip contact to tail contacts of the signal terminals 421 and 422. The length of the window 460A can be at least 1 mm, 1.5 mm, 2 mm, 2.5 mm, 3 mm, or more.

The ratios of “A1”/“A2” and “A3”/“A4” of the wafer assembly 200 can be the same, respectively, as the ratios “A5”/“A6” and “A7”/“A8” of the wafer assembly 400 in some preferred embodiments. The ratios of “A1”/“A2” and “A3”/“A4” can also be different, respectively, as compared to the ratios “A5”/“A6” and “A7”/“A8” in other cases. As one particular example, the ratios of “A1”/“A2” and “A3”/“A4” in the wafer assembly 200 can be different than the ratios “A5”/“A6” and “A7”/“A8” in the wafer assembly 400 due to different lengths of the signal terminals 221 and 222 in the wafer assembly 200 as compared to the lengths of the terminals 421 and 422 in the wafer assembly 400, different lengths of the window 270A as compared to the window 460A, and for other reasons.

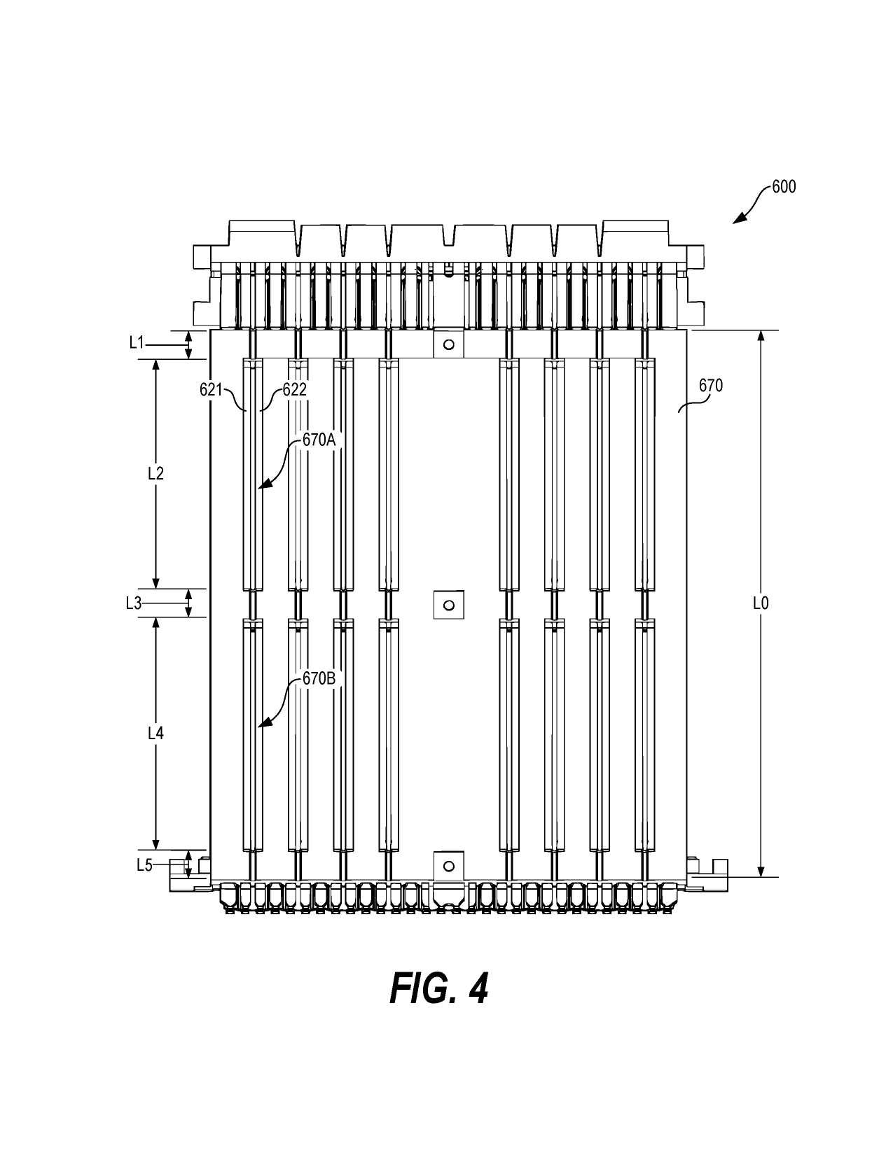

The dielectric insert 270 can also, in some cases and at some locations, wrap around the entire outer surface of the signal terminals 221 and 222 over certain lengths of the signal terminals 221 and 222 other than the length “L” (see FIG. 3C) of the window 270A. For example, the dielectric insert 270 contacts the portion A1 of the top surface of the signal terminal 221 over a first length (e.g., the length “L”) of the signal terminal 221, and the dielectric insert 270 wraps around and contacts the entire top, bottom, right, and left surfaces of the signal terminal 221 over a second length of the signal terminal 221 either before or after the first length. Similarly, the dielectric insert 460 can, in some cases and at some locations, wrap around the entire outer surface of the signal terminals 421 and 422 over certain lengths of the signal terminals 421 and 422 other than the length of the window 460A. The dielectric inserts 270 and 460 can also include two or more windows similar to the windows 270A and 460A. These and other examples are described below with reference to FIG. 4.

Among those in the connector 10, any one or more of the dielectric inserts 260, 270, 280, 360, 370, 460, 470, 560, and 570 can incorporate the concepts of dielectric crosstalk mitigation and cover a portion of top or bottom surfaces of signal terminals in the wafer assemblies 200, 300, 400, and 500 over windowed regions or lengths of the signal terminals. In the connector 10, the dielectric inserts 270, 360, 460, 470, and 570 are designed for dielectric crosstalk mitigation and cover a portion of top or bottom surfaces of signal terminals in the wafer assemblies 200, 300, 400, and 500. Some wafer assemblies include two or more dielectric inserts designed for dielectric crosstalk mitigation, such as the dielectric inserts 460 and 470 of the wafer assembly 400.

Not all of the dielectric inserts 260, 270, 280, 360, 370, 460, 470, 560, and 570 in the connector 10 are designed to cover a portion of top or bottom surfaces of signal terminals over windowed regions or lengths of the signal terminals. As shown in FIGS. 2A and 2C, for example, the dielectric insert 260 includes an open window 260A in which the dielectric insert 260 does not contact the signal or ground terminals of the wafer assembly 200 at all, over the entire window 260A. The dielectric insert 260 does not include any regions over which only a portion of top or bottom surfaces of any terminal conductors are covered by the dielectric insert 260. The dielectric insert 280 also may not include any regions over which only a portion of top or bottom surfaces of terminal conductors are covered.

FIG. 3D illustrates the sectional view designated B-B in FIG. 2B. FIG. 3D illustrates how the dielectric inserts 470 and 570 cover a portion of surfaces of signal terminals in the wafer assemblies 400 and 500, similar to the way shown in FIG. 3B. The dielectric insert 470 contacts surface regions of the signal terminals 421 and 422 over a length of a window in the dielectric insert 470. The surface regions of the signal terminals 421 and 422 that are covered by the dielectric insert 470 are less than the full surface areas of the signal terminals 421 and 422 over the length of the window. The dielectric insert 470 also contacts and covers the top surfaces of the ground terminals 420 and 423 over the length of the window. As also shown in FIG. 3D, the dielectric insert 570 contacts top surface regions of the signal terminals 521 and 522 over a length of a window in the dielectric insert 570. The top surface regions of the signal terminals 521 and 522 that are covered by the dielectric insert 570 are less than the full top surface areas of the signal terminals 521 and 522 over the length of the window. The dielectric insert 570 also contacts and covers the top surfaces of the ground terminals 520 and 523 over the length of the window.

FIG. 3E illustrates the sectional view designated C-C in FIG. 2B. FIG. 3E illustrates how the dielectric insert 360 covers a portion of surfaces of signal terminals in the wafer assembly 300, similar to the way shown in FIG. 3B. The dielectric insert 360 contacts surface regions of the signal terminals 321 and 322 over a length of a window in the dielectric insert 360. The surface regions of the signal terminals 321 and 322 that are covered by the dielectric insert 360 are less than the full surface areas of the signal terminals 321 and 322 over the length of the window. The dielectric insert 360 also contacts and covers the entire the top surfaces of the ground terminals 320 and 323 over the length of the window.

FIG. 4 illustrates a back view of a wafer assembly 600 including signal terminals 621 and 622 and a dielectric insert 670 according to various embodiments of the present disclosure. The dielectric insert 670 extends the full length “L0,” which runs along at least a portion of the full length of the signal terminals 621 and 622. The dielectric insert 670 also includes two windows 670A and 670B. The windows 670A and 670B extend lengths “L2” and “L4,” respectively, along the full length “L0” of the dielectric insert 670. The lengths “L2” and “L4” can be the same as or different than each other in other examples. The dielectric insert 670 can also include additional windows, such as three, four, or more windows similar to the windows 670A and 670B. The dielectric insert 670 can include a combination of the windows 670A and 670B and the open windows similar to the open window 260A shown in FIG. 2A.

Within or along the windows 670A and 670B, the dielectric insert 670 contacts a portion of at least one surface of each of the signal terminals 621 and 622, consistent with the concepts described herein. Outside the windows 670A and 670B, the dielectric insert 670 wraps around and entirely contacts all surface regions of the signal terminals 621 and 622. More particularly, the dielectric insert 670 wraps around and entirely contacts all external surfaces of the signal terminals 621 and 622 along the lengths “L1,” “L3” and “L5,” which are different lengths than the lengths “L2” and “L4,” respectively, of the windows 670A and 670B.

Thus, the dielectric insert 670 wraps around and entirely contacts all external surfaces of the signal terminal 621 over a first length “L1” of the signal terminal 621, the dielectric insert 670 contacts a portion of at least one surface of the signal terminal 621 over a second length “L2” of the signal terminal 621, the dielectric insert 670 wraps around and entirely contacts all external surfaces of the signal terminal 621 over a third length “L3” of the signal terminal 621, the dielectric insert 670 contacts a portion of at least one surface of the signal terminal 621 over a fourth length “L4” of the signal terminal 621, and the dielectric insert 670 wraps around and entirely contacts all external surfaces of the signal terminal 621 over a fifth length “L5” of the signal terminal 621.

In a similar way, the dielectric insert 670 wraps around and entirely contacts all external surfaces of the signal terminal 622 over a first length “L1” of the signal terminal 622, the dielectric insert 670 contacts a portion of at least one surface of the signal terminal 622 over a second length “L2” of the signal terminal 622, the dielectric insert 670 wraps around and entirely contacts all external surfaces of the signal terminal 622 over a third length “L3” of the signal terminal 622, the dielectric insert 670 contacts a portion of at least one surface of the signal terminal 622 over a fourth length “L4” of the signal terminal 622, and the dielectric insert 670 wraps around and entirely contacts all external surfaces of the signal terminal 622 over a fifth length “L5” of the signal terminal 622.

Terms such as “top,” “bottom,” “side,” “front,” “back,” “right,” and “left” are not intended to provide an absolute frame of reference. Rather, the terms are relative and are intended to identify certain features in relation to each other, as the orientation of structures described herein can vary. The terms “comprising,” “including,” “having,” and the like are synonymous, are used in an open-ended fashion, and do not exclude additional elements, features, acts, operations, and so forth. Also, the term “or” is used in its inclusive sense, and not in its exclusive sense, so that when used, for example, to connect a list of elements, the term “or” means one, some, or all of the elements in the list.

Combinatorial language, such as “at least one of X, Y, and Z” or “at least one of X, Y, or Z,” unless indicated otherwise, is used in general to identify one, a combination of any two, or all three (or more if a larger group is identified) thereof, such as X and only X, Y and only Y, and Z and only Z, the combinations of X and Y, X and Z, and Y and Z, and all of X, Y, and Z. Such combinatorial language is not generally intended to, and unless specified does not, identify or require at least one of X, at least one of Y, and at least one of Z to be included.

The terms “about” and “substantially,” unless otherwise defined herein to be associated with a particular range, percentage, or related metric of deviation, account for at least some manufacturing tolerances between a theoretical design and manufactured product or assembly, such as the geometric dimensioning and tolerancing criteria described in the American Society of Mechanical Engineers (ASME®) Y14.5 and the related International Organization for Standardization (ISO®) standards. Such manufacturing tolerances are still contemplated, as one of ordinary skill in the art would appreciate, although “about,” “substantially,” or related terms are not expressly referenced, even in connection with the use of theoretical terms, such as the geometric “perpendicular,” “orthogonal,” “vertex,” “collinear,” “coplanar,” and other terms.

The above-described embodiments of the present disclosure are merely examples of implementations to provide a clear understanding of the principles of the present disclosure. Many variations and modifications can be made to the above-described embodiments without departing substantially from the spirit and principles of the disclosure. In addition, components and features described with respect to one embodiment can be included in another embodiment. All such modifications and variations are intended to be included herein within the scope of this disclosure.

What is claimed is:

1. A connector, comprising:
a housing comprising a front port opening; and
a wafer assembly positioned in the housing, the wafer assembly comprising a signal terminal and a dielectric insert supporting the signal terminal, wherein:
the dielectric insert extends over and contacts a portion of a surface of the signal terminal along a length of the signal terminal.

2. The connector according to claim 1, wherein the portion of the surface of the signal terminal comprises 50% or less than a total surface region of the surface of the signal terminal along the length.

3. The connector according to claim 1, wherein:
a second portion of the surface of the signal terminal along the length is exposed within a window of the dielectric insert; and
the dielectric insert extends over and contacts an entire surface of the signal terminal along a second length of the signal terminal.

4. The connector according to claim 1, wherein:
the wafer assembly further comprises a shield;
the surface of the signal terminal comprises a top surface of the signal terminal; and
a bottom surface of the signal terminal faces the shield.

5. The connector according to claim 1, wherein:
the surface of the signal terminal comprises a top surface of the signal terminal; and
a bottom surface and side surfaces of the signal terminal are exposed along the length.

6. The connector according to claim 1, wherein:
the wafer assembly further comprises a ground terminal;
the dielectric insert extends over and contacts an entire surface of the ground terminal along the length of the signal terminal.

7. The connector according to claim 1, wherein:
the wafer assembly further comprises a shield and a ground terminal;
the dielectric insert extends over and contacts an entire top surface of the ground terminal along the length of the signal terminal; and
a bottom surface of the ground terminal contacts and is electrically coupled to the shield.

8. The connector according to claim 1, wherein:
the wafer assembly further comprises a second dielectric insert supporting the signal terminal; and
the second dielectric insert extends over and contacts a second portion of the surface of the signal terminal along a second length of the signal terminal.

9. The connector according to claim 1, wherein:
the wafer assembly further comprises a second signal terminal; and
the dielectric insert extends over and contacts a portion of a surface of the second signal terminal along the length of the signal terminal and along a second length of the second signal terminal within a window of the dielectric insert, the length of the signal terminal being the same as the second length of the second signal terminal.

10. A wafer assembly, comprising:
a signal terminal;
a ground terminal; and
a dielectric insert supporting the signal terminal and the ground terminal, wherein:
the dielectric insert extends over and contacts a portion of a surface of the signal terminal along a length of the signal terminal.

11. The wafer assembly according to claim 10, wherein the portion of the surface of the signal terminal comprises 50% or less than a total surface region of the surface of the signal terminal along the length.

12. The wafer assembly according to claim 10, wherein:
a second portion of the surface of the signal terminal along the length is exposed within a window of the dielectric insert; and
the dielectric insert extends over and contacts an entire surface of the signal terminal along a second length of the signal terminal.

13. The wafer assembly according to claim 10, wherein:
the wafer assembly further comprises a shield;
the surface of the signal terminal comprises a top surface of the signal terminal; and
a bottom surface of the signal terminal faces the shield.

14. The wafer assembly according to claim 10, wherein:
the surface of the signal terminal comprises a top surface of the signal terminal; and
a bottom surface and side surfaces of the signal terminal are exposed along the length.

15. The wafer assembly according to claim 10, wherein:
the wafer assembly further comprises a shield;
the dielectric insert extends over and contacts an entire top surface of the ground terminal along the length of the signal terminal; and
a bottom surface of the ground terminal contacts and is electrically coupled to the shield.

16. The wafer assembly according to claim 10, wherein:
the wafer assembly further comprises a second dielectric insert supporting the signal terminal; and
the second dielectric insert extends over and contacts a second portion of the surface of the signal terminal along a second length of the signal terminal.

17. The wafer assembly according to claim 10, wherein:
the wafer assembly further comprises a second signal terminal; and
the dielectric insert extends over and contacts a portion of a surface of the second signal terminal along the length of the signal terminal and along a second length of the second signal terminal within a window of the dielectric insert, the length of the signal terminal being the same as the second length of the second signal terminal.

18. A connector, comprising:
a housing comprising a slot for insertion of a board card edge interface; and
a wafer assembly positioned in the housing, the wafer assembly comprising a pair of signal terminals and a dielectric insert supporting the pair of signal terminals, wherein:
the dielectric insert extends over and contacts a portion of a surface of each signal terminal among the pair of signal terminals along a length of the pair of signal terminals.

19. The connector according to claim 18, wherein the portion of the surface of each signal terminal comprises 50% or less than a total top surface region of each signal terminal along the length.

20. The connector according to claim 18, wherein:
the wafer assembly further comprises a shield;
the surface of each signal terminal among the pair of signal terminals comprises a top surface; and
a bottom surface of each signal terminal among the pair of signal terminals faces the shield.
